(19) United States
(12) Patent Application Publication
(10) Pub. No.: US 2010/0332347 A1
(43) Pub. Date: Dec. 30, 2010

(54) Integrated Marketing System for a Jewel Common Market

(76) Inventor: Yung-Sung Liu, Taipei (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 12/873,442

(22) Filed: Sep. 1, 2010

Related U.S. Application Data
(63) Continuation-in-part of application No. 12/265,096, filed on Nov. 5, 2008.

(51) Int. Cl. G06Q 30/00

(52) U.S. Cl. 705/26.62; 705/27.1; 705/27.2

(57) ABSTRACT

An integrated marketing system for a jewel common market has a common marketing jewel source offered by the common marketing head office. The head office has a common market integration server and a full common marketing jewel database. The server has a management system and a website interface. To manage the data, the management system functions to manage the records of jewel enter, selling, and deposit. Customers may get the data regarding the common marketing jewels on the website interface and then purchase a random commonly marketed jewel from the head office or the dealers, or may purchase the commonly marketed jewels directly from one of the dealers.

The integrated marketing system for a jewel common market further includes the stock order management functions which contains a transaction categories, a gemstone information and a transaction signals for the user to purchase or inquire all the jewels matched by the system.

### BACKGROUND OF THE INVENTION

1. Field of the Invention

This invention relates to an integrated marketing system for a jewel common market and particularly to a system through which dealers may market all the jewels and especially properly diamonds that are offered by a common marketing head office.

2. Description of the Related Art

In the industry, although the diamond is featured with low rate of gross profit and low match point, the turnover is very high and some percentage point is enough to reach a scale of economy. If the selling price is lower than the market price by 30 percent through 50 percent and 5 times through 10 times of volume of sales is achieved, the turnover and the profit increase. Thus, in the premise of what is mentioned above, as long as the transfer rate of jewels increases, the rate of stocks decreases, and shortage is balanced with abundance, the success of industry may come true.

Thus, a system according to this invention integrates a purchase management system, a shipment management system and a dealer system, an ERP system, a network system and the like into a common market server for all the dealers and customers to enhance the result of trading and make the head office easily manage and control, thereby the dealing system in the mode being named an integrated marketing system for a common market.

When the conventional silverware dealer indeed realizes the necessity of transformation, it's time for us to establish the merchandise and put into effect the operation mode of the common market and integrated marketing. We just think that after choosing a style of merchandise on a website or newspaper, the customer may see and take it in a nearby branch office (transformed from the conventional silverware store after joining in) from a community to a city everywhere; namely, it is convenient as a convenience store, sells well-found kinds of goods in a fair price, and offers a service of dignity and honor. Accordingly, a fully innovative integrated marketing system for a jewel common market is provided in this invention to improve the conventional manner of dealing jewels.

Consequently, because of the technical defects of described above, the applicant keeps on carving unflaggingly through wholehearted experience and research to develop the present invention, which can effectively improve the defects described above.

### SUMMARY OF THE INVENTION

It is a main object of this invention to provide an integrated marketing system for a jewel common market, which is mainly provided with a common marketing jewel source offered by the common marketing head office. After purchasing parts of the common marketing jewels from the common marketing head office, a dealer may sell the jewels and also other common marketing jewels. The common marketing head office has a common market integration server and a full common marketing jewel database. The common market integration server is provided with a management system and a website interface. In order to manage the data in the full common marketing jewel database, the management system functions to manage the records of jewel enter, selling, and deposit. On a network, the website interface shows all the data of common marketing jewels that is stored in the full common marketing jewel database. Customers may get the data regarding the common marketing jewels on the website interface and then purchase a random commonly marketed jewel from the common marketing head office or the dealer, or may purchase the commonly marketed jewels directly from one of the dealer.

In this invention, the integrated marketing system for the jewel common market further brings a concept of jewel common marketing in which a branch office may be established even if the dealer has, for example, a little revolving fund as capital, and hundred millions of common marketing jewel resources are given. What is mentioned above is the intention to establish the dealing market in this invention, and all the commonly marketed jewels are capable of the inflation proof in value and the appreciation, which may significantly lower the volume of stocks and the cost, give their best back to the customers, make apparent the result of jewel selling, and help the dealer obtain larger profit.

Next in this invention, the integrated marketing system for the jewel common market next is provided with a nationwide large print medium and a network medium created by the common marketing head office for the purpose of public marketing and international diamond trading quotation listing. The information is both published daily in the print medium and publicized in the national large print medium at irregular intervals, or made into CF that is broadcasted in a TV medium. Thus, the cost of advertisement the dealer pays for is made to decrease significantly.

In this invention, after the dealer is added to the system according to this invention, thanks to the plan on the common market and integrated marketing, each regional dealer has full rights of sale by inspection of nationwide goods and resources for significant increase of the probability of dealing with the customer; namely, unless the product is a unit of extremely special merchandise, such as a big diamond of more than ten karats, the goods may almost be seen at the store as long as the customer requests to inspect the goods, thereby the successful occasion of dealing in the jewel being significantly increased. After stocking with goods from the common marketing head office, the dealer may put them on the market and have full rights in exchanging goods, which makes the dealer not to worry about choice of wrong goods. With the control of the management system, the branch offices may also transfer the goods from each other through the common marketing head office to satisfy the customers. The stocks are made to increase because the dealer shops wrong goods and the head office disagree to recover the stocks of the dealer, making the supply chain cause many issues with time going by. The issue on trading is impossibly burdened by only the dealer, and after a long period of time, it is tough for the dealer to run or drives the dealer reduce the price to sell the inventory, which seriously destroys the brand.

This invention helps the dealer deal, freely transfer the nationwide merchandise, ease the pressure of the high cost of a shop and solve the issue on heavy stocks and revolving fund, and even thoroughly turn the phenomenon of the high cost and low turnover of the jewel industry to that of the high cost and high circulation, thereby the markets being integrated by the dealers.

The following advantages are included in the integrated marketing system for the jewel common market according to this invention.
(1) The system grows in strength because the dealer purchase for jewel common marketing, and the jewels are sold easily and fast for risk reduction because more dealers co-work with each other.
(2) Even if parts of common marketed jewels purchased by the dealer are not accepted by the customers, they are sold none the less through another dealer, thereby the risk of product storage being reduced and the pressure of stocks being lowered. All the dealers have well-found merchandise because they are allowed to sell other commonly marketed jewels and transfer goods from the head office.
(3) Each of the customers may easily choose a proper jewel by reading enormous data on the commonly marketed jewels and may also purchase it from a nearby dealer; through the declared list price, the customer may transact in security and is not cheated to buy expensive jewels.
(4) The system according to this invention may fully improve the conventional jewel marketing system and work in convenience and security.

In order to further know the features and technical means of this invention, refer to the following detailed description according to this invention accompanied with drawings.

### BRIEF DESCRIPTION OF THE DRAWINGS

FIG. 1 is the structure of a system according to this invention;

FIG. 2 is a schematic view illustrating the operation of the system according to this invention;

FIG. 3 is a schematic view illustrating the functions of a management system according to this invention; and

FIG. 4 is a structural view of a website interface according to this invention.

FIG. 5 is a structural view illustrating the stock order management functions according to this invention;

FIG. 6 is a flow chart describing the order application of the system to this invention;

FIG. 7 is a flow chart describing the replacement application of the system to this invention;

FIG. 8 is a flow chart describing the appreciation application of the system to this invention;

FIG. 9 is a flow chart describing the appreciation period ended and returned goods application of the system to this invention.

### DETAILED DESCRIPTION OF THE PREFERRED EMBODIMENTS

It is to be noted that the following descriptions of preferred embodiments of this invention are presented herein for purpose of illustration and description only; it is not intended to be exhaustive or to be limited to the precise form disclosed.

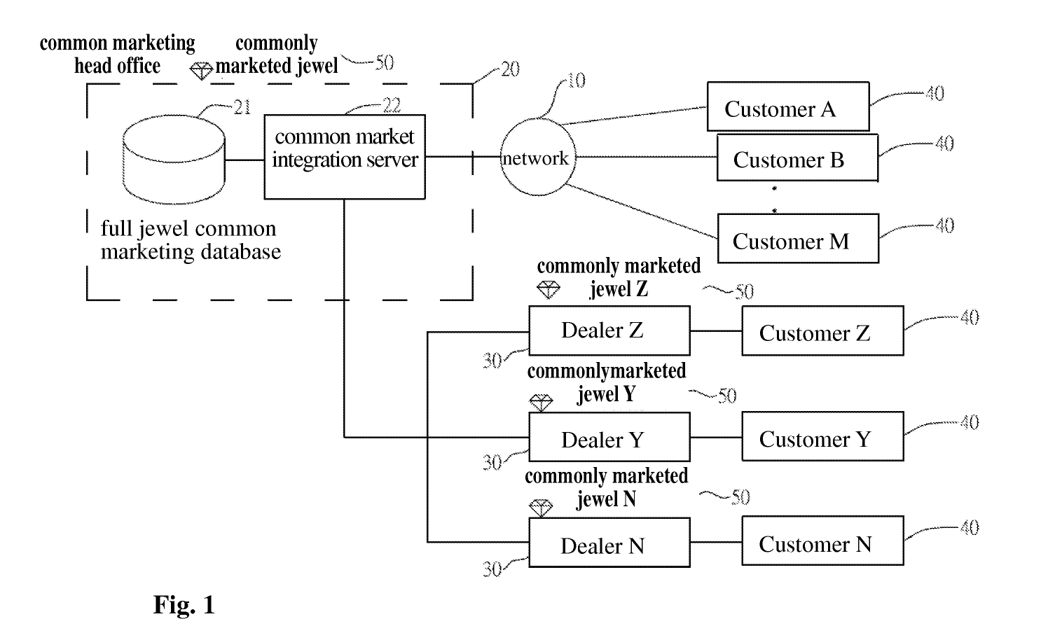

Referring to FIG. 1, an integrated marketing system for a jewel common market according to this invention comprises a network 10, a common marketing head office 20, and a plurality of dealers 30 and a plurality of customers 40. Through the system, commonly marketed jewels 50 are traded.

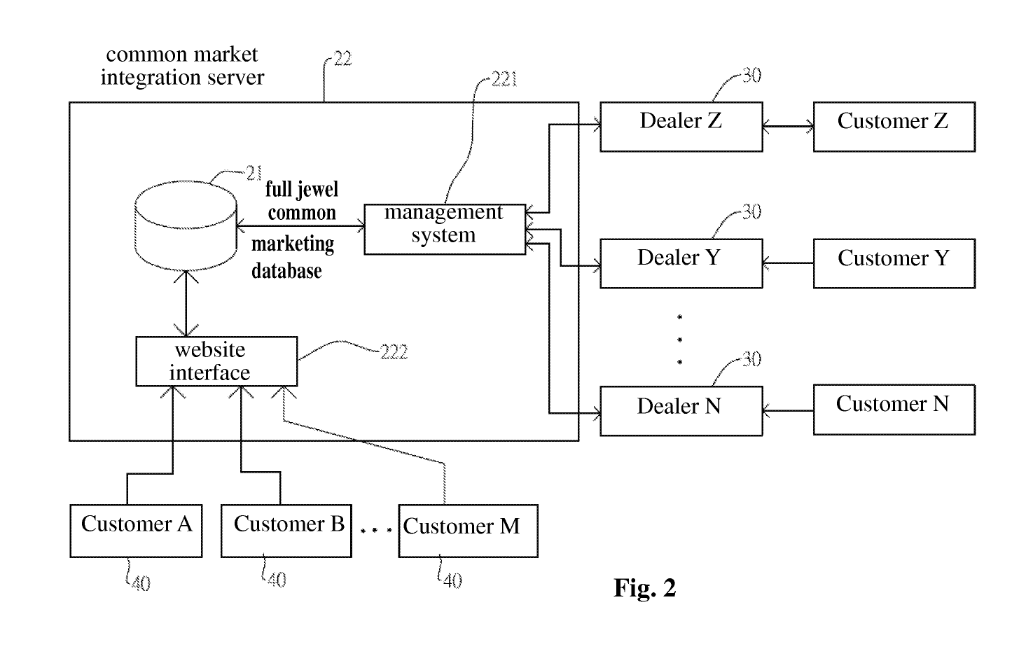

The network 10 according to this invention is a communication network, such as a wired or wireless communication network. The common marketing head office 20 offers the source of all commonly marketed jewels 50 and is provided with a common market integration server 22 and a full common marketing jewel database 21. Referring to FIG. 2, the common market integration server 22 is provided with a management system 221 and a website interface 222. The management system 221 is connected to the dealers 30, while the website interface 222 is connected to a terminal of customer 40, thereby the website data being shown.

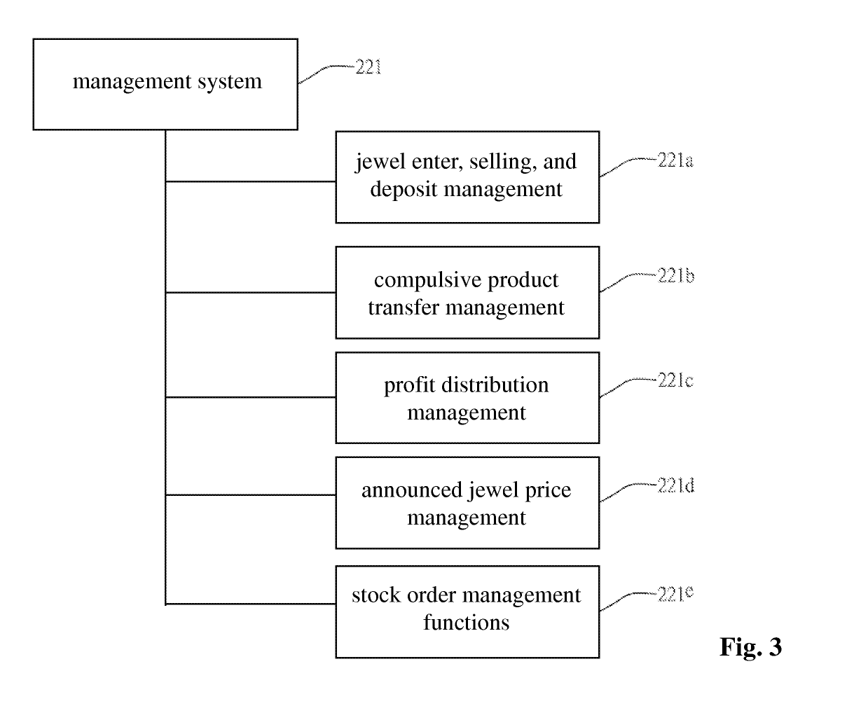

Referring to FIG. 3, the management system 221 is featured with: a jewel enter, selling, and deposit management function 221a that is used to manage recorded data in the full common marketing jewel database 21; a compulsive product transfer management function 221b that works to transfer parts of the commonly marketed jewels sold by a dealer to another dealer for dealer with the customer; a profit distribution management function 221c that distributes, to the head office and the dealers, the profit gained from the dealing of goods compulsorily transferred by the arranged proportion, and an announced jewel price management function 221d, in which the price is announced; and an stock order management functions 221e, in which the jewels transacted.

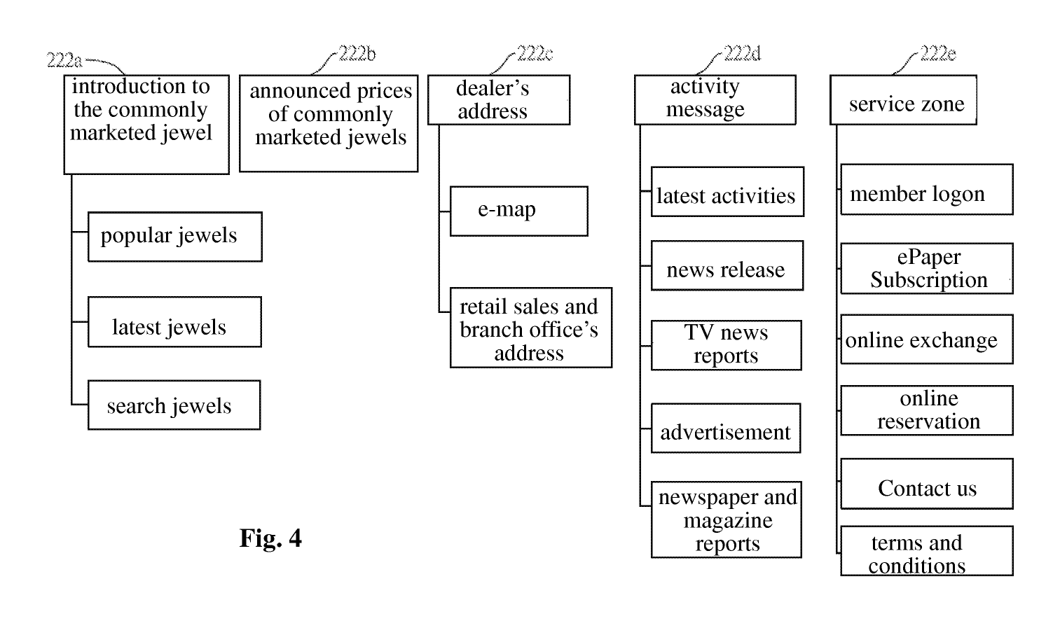

Referring to FIG. 4, through the communication network 10, the website interface 222 may show the data regarding all the commonly marketed jewels in the full common marketing jewel database 21, a piece of introduction 222a to the commonly marketed jewels, and the data may be searched depending on popular jewels, latest jewels and the like. The website interface 222 may further show the announced prices 222b of commonly marketed jewels. The website interface 222 may further show each dealer address 222c that may be marked in an e-map. The website interface 222 may further show activity messages 222d released by the common marketing head office, including latest activities, news release, TV news reports, newspaper and magazine reports, advertisement or the like. The website interface 222 further offers a service zone 222e that comprises the functions of Member Logon, ePaper Subscription, Online Exchange, Online Reservation, Contact us, and The Terms and Conditions.

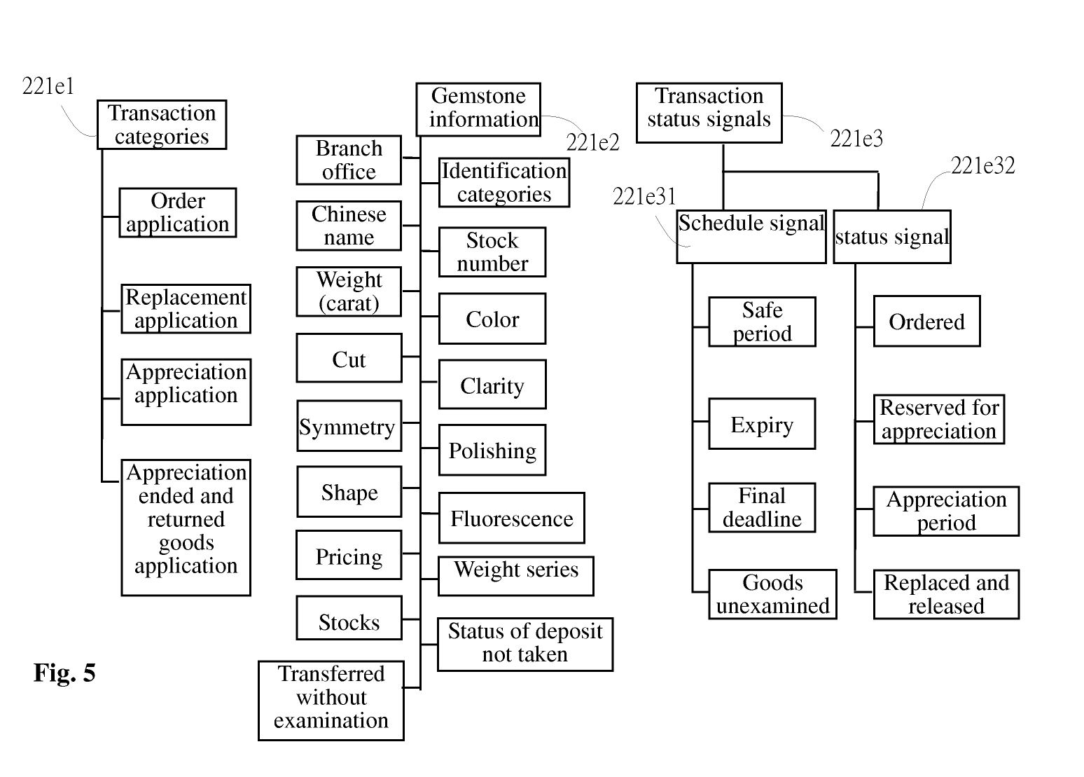

Referring to FIG. 3 & FIG. 5, the management system 221 of the present invention is featured with the stock order management functions 221e which contains a transaction categories 221e1 that allows the user to select any of the available fields from the order application, replacement application, appreciation application, and appreciation period ended and returned goods application; a gemstone information 221e2 which provides all the options of identification category, branch office, stock number, Chinese name, color, weight (carat), clarity, cut, polishing, symmetry, fluorescence, shape, and pricing, etc., for the user to determine a matching item; a transaction signals 221e3 which features a schedule signal 221e31 and a status signal 221e32. In which the schedule signal 221e31 represents the safe period, expiry, final deadline, and the goods unexamined. The status signal 221e32 represents the ordered, reserved for appreciation, appreciation period, and replaced and released of the jewels. We have more description regarding the transaction status signals 221e3 as below.

If the jewelry is ordered within 24 hours, the schedule signal 221e31 will flash as the safe period signal and the status signal 221e32 will flash as ordered signal. If the jewelry has been order over 24 hours but not shipped out yet, the schedule signal 221e31 will flash as expiry signal and the status signal 221e32 will flash as ordered signal. If the jewelry has been ordered over 48 hours but not shipped out yet, the schedule signal 221e31 will flash as final deadline and the status signal 221e32 will flash as ordered signal. If the jewelry has been ordered and shipped out but not examined yet by the dealer, the schedule signal 221e31 will flash as the goods unexamined signal but the status signal 221e32 will flash as ordered signal. If the jewelry has been reserved for appreciation then the schedule signal 221e31 will flash as safe period signal and the status signal 221e32 will flash as reserved for appreciation signal. If the jewelry has been transferred over 24 hours but not shipped out yet, the schedule signal 221e31 will flash as expiry signal and the status signal 221e32 will flash as reserved for appreciation signal. If the jewelry has been transferred over 36 hours but not shipped out yet, the schedule signal 221e31 will flash as final deadline signal and the status signal 221e32 will flash as reserved for the appreciation signal. If the jewelry has been reserved for appreciation within 5 days, the schedule signal 221e31 will flash as safe period signal and the status signal 221e32 will flash as the appreciation period signal. If the jewelry has been reserved for appreciation for 6 days, the schedule signal 221e31 will flash as expiry signal and the status signal 221e32 will flash as appreciation period. If the schedule signal 221e31 flashes as the final deadline and the status signal 221e32 flashes as the appreciation period then it means the final day for the appreciation of the jewelry. If the schedule signal 221e31 flashes as goods unexamined signal and the status signal 221e32 flashes as appreciation period signal then it means the reserved for appreciation of the jewelry has been returned but not examined by the dealer of the transferred jewelry. If the schedule signal 221e31 flashes as the goods unexamined signal and the status signal 221e32 flashes as the replaced and released then it means the jewelry will be replaced and released.

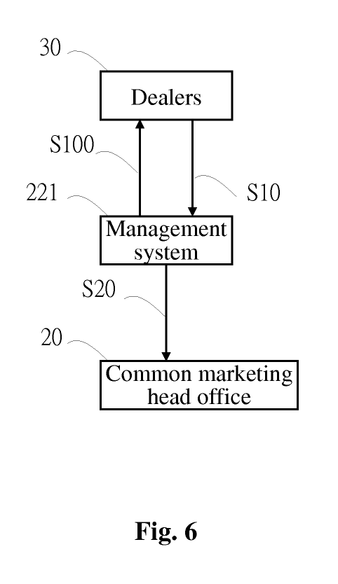

Referring to FIG. 6, a flow chart featuring when the dealers 30 purchase the jewels through the order application S10 provided by the management system 221 then correspondently the system will display a shipping application S20 to the common marketing head office 20 to ship out the jewels and the invoice S100 to the dealers 30.

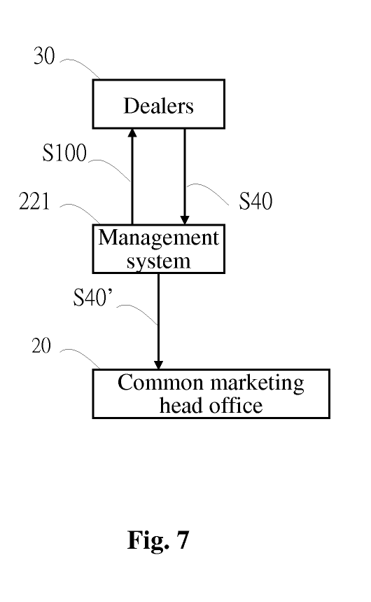

Referring to FIG. 7, a flow chart featuring when the dealers 30 replace the jewels through the replacement application S40 provided by the management system 221 then correspondently the management system 221 will display a replacement application S40′ to the common marketing head office 20 to ship out the new jewels and return the replaced jewels and the invoice application S100 to the dealers 30.

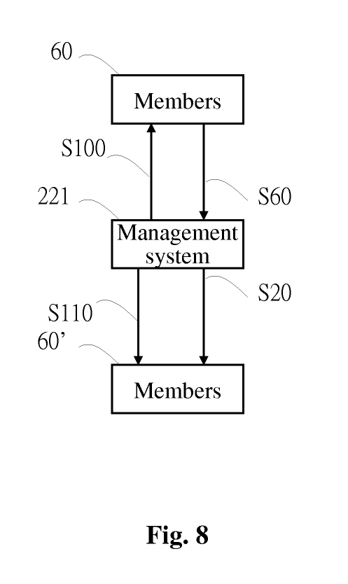

Referring to FIG. 8, members 60 or members 60′ represent the common marketing head office 20 or the dealers 30. When the members 60 loan the jewels for the customers 40 appreciating the goods through the appreciation application S60 provided by the management system 221 then correspondently the management system 221 will display a shipping application S20 to the members 60′ to ship the jewels out. If members 60 sell the jewels within the appreciation period then management system 221 will provide the invoice S100 to the members 60 and the bonus application S110 to the members 60′.

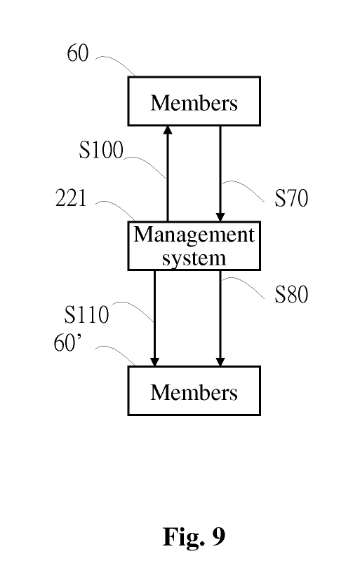

Referring to FIG. 9, if members 60 do not sell the jewels within the appreciation period but the members 60 have already ordered the appreciation period ended and returned the goods application S70 through the management system 221, the management system 221 will display an appreciation ended and withdrawn the goods application S80 to the members 60′ to withdraw the jewels. If members 60 have not returned the jewels over the appreciation period then it will be deemed as the members 60 have sold the jewels and the management system 221 will display the invoice application S100 to the members 60 and the bonus application S110 to the members 60′.

Each of the dealers 30 listed in the system according to this invention purchases parts of the commonly marketed jewels 50 from the common marketing head office 20, and manage through the management system 221 the data regarding the jewels 50 that is recorded in the full common marketing jewel database 21. Customers (A˜M) 40 may get the data regarding the common marketing jewels 50 on the website interface 222 connected to the communication network 10 and then purchase a random commonly marketed jewel from the common marketing head office 20 or the dealers 30. Customers (Z˜N) 40 may also purchase the commonly marketed jewels 50 directly from one of the dealers (Z˜N) 30.

The system according to this invention helps the dealer deal, freely transfer the nationwide merchandise, ease the pressure of the high cost of a shop and solve the issue on heavy stocks and revolving fund, and even thoroughly turn the phenomenon of the high cost and low turnover of the jewel industry to that of the high cost and high circulation, thereby the markets being integrated by the dealers.

The integrated marketing system for the jewel common market according to this invention may, through the public market, allow the customers to choose the various merchandise kept by the dealers, and nationwide silver stores are organized to serve as the common market for enhancement of the strategy of selling. The commission and the bonus the dealers care may be distributed by using the profit distribution management function in the management system.

For example, owing to the customer's request, if the common marketed jewel is transferred by the head office from a dealer in Taipei to a dealer in Kaohsiung and then sold, the dealer may win 2% bonus and the dealer in Kaohsiung that successfully sells it out may win 5% gross profit. However, the 2% bonus is first appropriated by the common marketing head office to the dealer in Taipei and thus not brought into the year-end bonus. However, if the branch office in Kaohsiung finishes in transferring the goods but fail to sell it, the branch office may return them to the head office; once the branch finishes the dealing, the head office will appropriate the 2% bonus to the dealer in Taipei but the branch office cannot request to return and exchange the goods for any reason. In the mechanism of management of the compulsive product transfer and profit distribution, the dealing in the commonly marketed jewels is surely smooth.

To sum up, this invention helps the dealer deal, freely transfer the nationwide merchandise, ease the pressure of the high cost of a shop and solve the issue on heavy stocks and revolving fund, and even thoroughly turn the phenomenon of the high cost and low turnover of the jewel industry to that of the high cost and high circulation, thereby the markets being integrated by the dealers. Thus, this invention is made to be improved and practical to meet the requirements of application for protection under patent law.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An integrated marketing system for a jewel common market, comprising:
a communication network;
a commonly integrated website server storing a management system, a website interface and an inventory management, in which the management system contains a jewel enter, selling, and deposit management function to manage the data regarding the commonly marketed jewels that is recorded in the full common marketing jewel database, the website interface shows the data of commonly marketed jewels that is stored in the full common marketing jewel database, the stock order management functions display a transaction categories, a gemstone information and a transaction status signals.

2. The integrated marketing system for the jewel common market according to claim 1, wherein the management system is further provided with a compulsive product transfer management function that transfers one of the commonly marketed jewels kept by one dealer to another dealer for dealing with the customer.

3. The integrated marketing system for the jewel common market according to claim 2, wherein the management system is featured with a profit distribution management function that distribute to the head office and related dealer the profit gained from dealing of compulsive transfer.

4. The integrated marketing system for the jewel common market according to claim 1, wherein the management system is further featured with an announced jewel price management function.

5. The integrated marketing system for the jewel common market according to claim 1, wherein the website interface shows the data in the full common marketing jewel database and the data may be searched depending on popular jewels, latest jewels and the like.

6. The integrated marketing system for the jewel common market according to claim 1, wherein the website interface may further show the announced prices of commonly marketed jewels.

7. The integrated marketing system for the jewel common market according to claim 1, wherein the website interface may further show the dealer's address.

8. The integrated marketing system for the jewel common market according to claim 7, wherein the dealer's address may be shown in an e-map.

9. The integrated marketing system for the jewel common market according to claim 1, wherein the website interface may further show activity messages released by the common marketing head office.

10. The integrated marketing system for the jewel common market according to claim 1, wherein the website interface further offers a service zone that is featured with the functions of Member Logon, ePaper Subscription, Online Exchange, Online Reservation, Contact Us, and The Terms and Conditions.

11. The integrated marketing system for the jewel common market according to claim 1, wherein the transaction signals include a schedule signal and status signal.

12. The integrated marketing system for the jewel common market according to claim 11, wherein the schedule signal represents safe period, expiry, final deadline, and goods unexamined.

13. The integrated marketing system for the jewel common market according to claim 11, wherein the status signal represents ordered, reserved for appreciation, appreciation period, and replaced and released of the jewels.
